(19) United States
(12) Patent Application Publication
(10) Pub. No.: US 2022/0005365 A1
(43) Pub. Date: Jan. 6, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yurika TANAKA, Yokosuka-shi (JP); Shuichi SAWADA, Nagoya-shi (JP); Takaharu UENO, Nagoya-shi (JP); Shin SAKURADA, Toyota-shi (JP); Daiki YOKOYAMA, Gotemba-shi (JP); Genshi KUNO, Kasugai-shi (JP)

(73) Assignee: TOYOTA JIDOSHA KABUSHIKI KAISHA, Toyota-shi (JP)

(21) Appl. No.: 17/362,491

(22) Filed: Jun. 29, 2021

(30) Foreign Application Priority Data
Jul. 2, 2020 (JP) 2020-114829

(51) Int. Cl. G09B 5/02; G06F 40/20; G06K 9/00; G09B 19/00

(52) U.S. Cl. CPC G09B 5/02; G09B 19/00; G06K 9/00604; G06F 40/20

(57) ABSTRACT

There is provided a technology that can improve the convenience of users who are reading books. An information processing apparatus has a controller that determines a focus sentence in a subject book that a user is reading. The focus sentence is a sentence on which the user is focusing attention. The controller analyzes what the focus sentence describes and obtains related information relating to what the focus sentence describes. Moreover, the controller executes the processing for causing a user's terminal that the user is using to display the related information.

### CROSS-REFERENCE TO RELATED APPLICATIONS

This application claims the benefit of Japanese Patent Application No. 2020-114829, filed on Jul. 2, 2020, which is hereby incorporated by reference herein in its entirety.

### BACKGROUND

### Technical Field

The present disclosure relates to a technology for processing information related to books.

### Description of the Related Art

There is a known technology that enables a user who is reading a paper book to add a bookmark on a desired page of an electronic book corresponding to the paper book by capturing an image of the page of the paper book by a user's terminal (see, for example, Patent Literature 1 in the citation list below).

### CITATION LIST

### Patent Literature

Patent Literature 1: Japanese Patent Application Laid-Open No. 2015-041131

### SUMMARY

An object of this disclosure is to provide a technology that can improve the convenience of users who are reading books.

Disclosed herein is an information processing apparatus. The information processing apparatus may comprise, for example, a controller including at least one processor, the processor being configured to execute the processing of:

determining a focus sentence in a subject book that a user is reading, the focus sentence being a sentence on which the user is focusing attention;

analyzing what the focus sentence describes and obtaining related information relating to what the focus sentence describes; and

causing a user's terminal that the user is using to display the related information.

Also disclosed herein is an information processing method. The information processing method may comprise the following steps of processing executed by a computer:

a first step of determining a focus sentence in a subject book that a user is reading, the focus sentence being a sentence on which the user is focusing attention;

a second step of analyzing what the focus sentence describes and obtaining related information relating to what the focus sentence describes; and

a third step of causing a user's terminal that the user is using to display the related information.

Also disclosed herein is an information processing program for implementing the above-described information processing method and a non-transitory storage medium in which this information processing program is stored.

This disclosure provides a technology that can improve the convenience of users who are reading books.

### BRIEF DESCRIPTION OF DRAWINGS

FIG. 1 is a diagram illustrating the general configuration of a book management system to which the technology disclosed herein is applied.

FIG. 2 is a block diagram schematically illustrating exemplary components of the book management system.

FIG. 3 illustrates an exemplary structure of a book information table.

FIG. 4 is a flow chart of a process executed by a server apparatus.

### DESCRIPTION OF EMBODIMENTS

The information processing apparatus disclosed herein is applied to a system for providing information useful for a user who is reading a book. This system will also be referred to as the “book management system” hereinafter. The book management system includes an information processing apparatus according to this disclosure and a terminal used by a user. The terminal used by a user will be referred to as the “user's terminal” hereinafter. The user's terminal is a terminal capable of communicating with the information processing apparatus. The user's terminal may be, for example, a terminal that the user can carry, such as a smartphone or a cellular phone, or a stationary personal computer. When the user is reading a book, the information processing apparatus provides information relating to a sentence in the book on which the user is focusing attention to the user through the user's terminal.

When there is a sentence that describes something interesting to the user or difficult for the user to understand, the user may wish to search for information or literature relating to what the sentence describes. However, it may possibly take time and effort for the user to find useful information or literature.

The information processing apparatus disclosed herein has a control unit. When the user is reading a book, the control unit determines a sentence in this book (which will be referred to as the “subject book”) on which the user is focusing attention. This sentence will be referred to as the “focus sentence”. In this process, the control unit may, for example, detect the line of sight of the user by analyzing an image of the user captured by a camera (e.g. a visible light camera or a infrared camera) and determine the focus sentence on the basis of the detected line of sight. Then, the control unit analyzes what the focus sentence thus detected describes and obtains information relating to what the focus sentence describes. This information will also be referred to as “related information” hereinafter. Then, the control unit performs a processing for causing the user's terminal to display the related information thus obtained. The information relating to what the focus sentence describes is displayed automatically on the user's terminal. In consequence, the user can see or read the related information displayed on the user's terminal to deepen the understanding of what the focus sentence describes. Thus, the user can deepen the understanding of what the focus sentence describes without taking time or effort of finding information or literature for reference that relates to what the focus sentence describes. Therefore, the information processing apparatus disclosed herein can improve the convenience of the user who is reading a book.

The control unit may analyze what the focus sentence describes and obtain information suitable for explanation of what the focus sentence describes as related information. For example, in the case where what the focus sentence describes is a practice problem for learning, the control unit may obtain information suggesting how to solve the practice problem (or a hint for solving the problem) as related information. In the case where what the focus sentence describes relates to a component of an automobile, the control unit may obtain information that explains the function or the mechanism of that component as related information. In consequence, the user will be helped to understand what the focus sentence describes.

The control unit may analyze what the focus sentence describes and obtain information similar to what the focus sentence describes as related information. For example, in the case where what the focus sentence describes is a practice problem for learning, the control unit may obtain information relating to a practice problem similar to that practice problem as related information. In the case where what the focus sentence describes relates to a component of an automobile, the control unit may obtain information relating to a similar component that has a similar function as that component or a similar component that has a similar mechanism as that component as related information. In consequence, the user will be helped to deepen understanding of what the focus sentence describes.

If information relating to what the focus sentence describes is contained in the subject book, the control unit may obtain information indicating a page of the subject book that contains a description of information relating to what the focus sentence describes as related information. Such a page will also be referred to as a “related page” hereinafter. Then, the information indicating a related page is displayed on the user's terminal, thereby saving time and effort for the user to search for a related page.

If information relating to what the focus sentence describes is contained in a book other than the subject book, the control unit may obtain information indicating a book other than the subject book that contains information relating to what the focus sentence describes as related information. Such a book other than the subject book will also be referred to as a “related book” hereinafter. Then, the information suggesting a related book is displayed on the user's terminal, thereby saving time and effort for the user to search for a related book.

If related information is displayed on the user's terminal immediately after the user starts to read each sentence in the subject book, the user cannot have enough time to try to understand each sentence in some cases, possibly leading to user's decreased understanding of each sentence. Moreover, information relating to a sentence that is not interesting to the user or is easy for the user to understand is also likely to be displayed on the user's terminal. This can bother the user.

To avoid the above problems, the control unit may execute the processing for causing the user's terminal to display related information on condition that the length of time over which the user is focusing attention on a focused sentence exceeds a predetermined threshold or that the number of times that the user focuses attention on a focused sentence exceeds a predetermined threshold. This is based on the finding that if a sentence is interesting to the user or is difficult for the user to understand, the user tends to focus attention on that sentence for a longer period of time or read that sentence several times repeatedly. The aforementioned predetermined threshold is a threshold of the length of time through which the user is focusing attention on a focused sentence or a threshold of the number of times that the user focuses attention on a focused sentence above which it may be assumed that the focus sentence is interesting to the user or difficult for the user to understand. This threshold is determined in advance by a statistical method. This can improve the convenience of the user without inviting a decrease in the understanding of the sentence by the user or bothering the user.

The subject book to which the technology disclosed herein is directed may be a paper book. In the case where the subject book is a paper book, it takes longer time or requires more effort to search for related information than in the case where the subject book is an electronic book. Therefore, when applied to a paper book, the information processing apparatus disclosed herein can improve the convenience of the user with improved reliability.

### Embodiment

In the following, a specific embodiment of the technology disclosed herein will be described with reference to the drawings. It should be understood that the dimensions, materials, shapes, relative arrangements, and other features of the components that will be described in connection with the embodiment are not intended to limit the technical scope of the disclosure only to them, unless otherwise stated.

What is described in the following as an embodiment is a system for providing useful information to a user who is reading a book to which the information processing apparatus according to this disclosure is applied. This system will also be referred to as the “book management system” hereinafter. In the following, the book management system will be described with reference to an exemplary case where the book the user is reading (i.e. the subject book) is a paper book that contains practice problems for learning.

### (Outline of Book Management System)

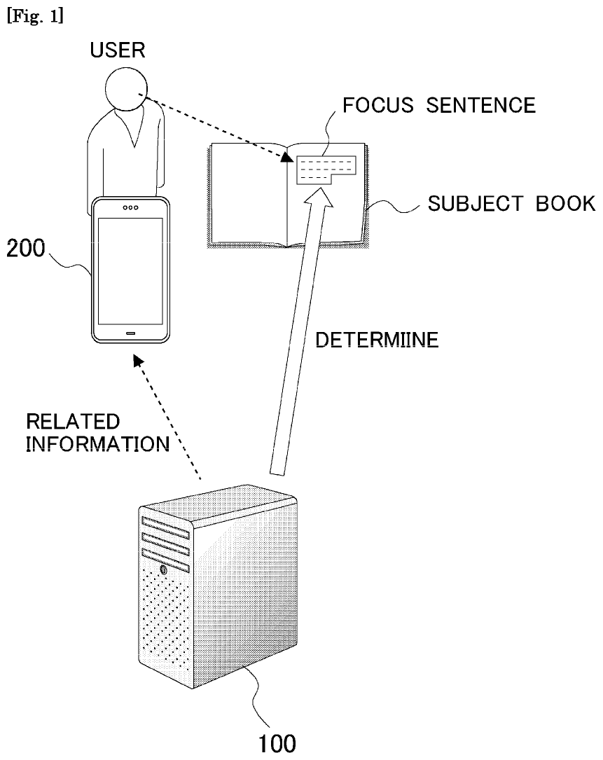

FIG. 1 is a diagram illustrating the general configuration of the book management system according to the embodiment. The book management system according to the embodiment includes a server apparatus 100 and a user's terminal 200. While the exemplary system illustrated in FIG. 1 includes only one user's terminal 200, the number of user's terminals 200 that are under the management of the book management system may be two or more.

The user's terminal 200 is a terminal used by a user. The user's terminal 200 presents information provided from the server apparatus 100 to the user. In the illustrative case described here, while the user is reading a book, the user's terminal 200 presents to the user information relating to what a sentence in the book on which the user is focusing attention.

The server apparatus 100 provides useful information relating to the book the user is reading (i.e. the subject book) to the user through the user's terminal 200. The server apparatus 100 determines the sentence in the book on which the user is focusing attention (i.e. the focus sentence) and obtains information relating to what the focus sentence thus determined describes (i.e. related information). Then, the server apparatus 100 provides the related information thus obtained to the user through the user's terminal 200.

### (System Configuration)

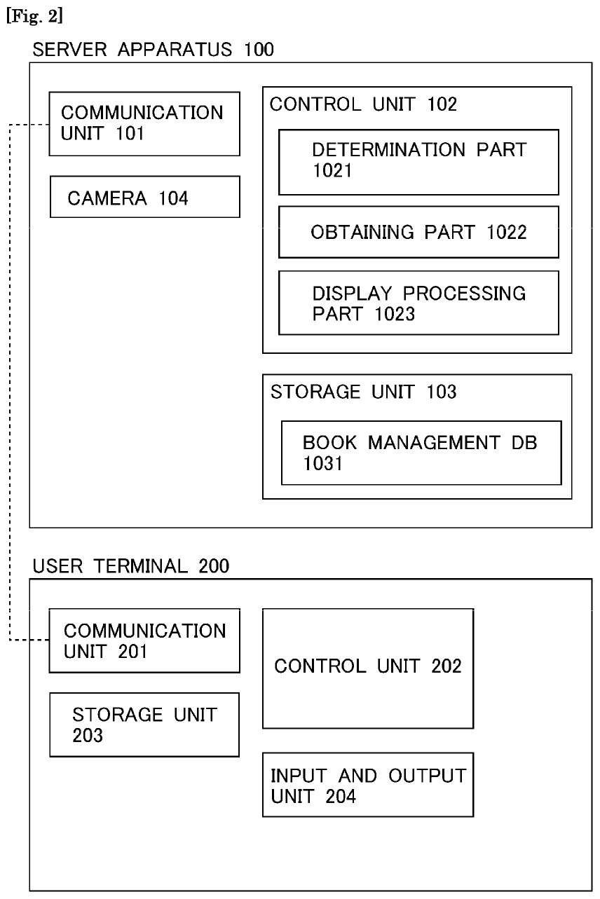

The configuration of the book management system according to the embodiment will now be described with reference to FIG. 2. FIG. 2 is a block diagram illustrating exemplary configurations of the server apparatus 100 and the user's terminal 200 illustrated in FIG. 1.

(Server Apparatus 100)

As described above, the server apparatus 100 is an information processing apparatus that performs processing related to focus sentences describe while the user is reading a subject book. The server apparatus 100 may be constituted by a general-purpose computer. For example, the server apparatus 100 includes a processor, such as a CPU or a GPU, a main storage unit, such as a RAM or ROM, an auxiliary storage unit, such as an EPROM, a hard disk drive, or a removable medium, and a camera 104. The removable medium may be a recording medium, such as a USB memory, a CD, or a DVD. The auxiliary storage unit stores an operating system (OS), various programs, and various tables. The processor executes a program(s) stored in the auxiliary storage unit to implement functions for achieving desired purposes that will be described later. Some or all the functions of the server apparatus 100 may be implemented by a hardware circuit(s), such as an ASIC or an FPGA.

As illustrated in FIG. 2, the server apparatus 100 of this embodiment includes a communication unit 101, a control unit 102, a storage unit 103, and a camera 104. The configuration of the server apparatus 100 is not limited to that illustrated in FIG. 2, but some components may be eliminated, replaced by other components, or added fitly.

The communication unit 101 connects the server apparatus 100 to a network. For example, the communication unit 101 communicates with the user's terminal 200 via the network using a communication network, such as LAN (Local Area Network), WAN (Wide Area Network), or Wi-Fi (registered trademark). The communication unit 101 may communicate with the user's terminal 200 using a mobile communication service, such as 5G (5th Generation) mobile communications or LTE (Long Term Evolution) mobile communications, or a wireless communication network, such as Wi-Fi.

The control unit 102 is constituted by a processor, such as a CPU, and performs overall control of the server apparatus 100. The control unit 102 in the system of this embodiment has, as functional modules, a determination part 1021, an obtaining part 1021, and a display processing part 1023. The control unit 102 implements these functional modules by executing programs stored in the storage unit 103 by the processor.

The determination part 1021 determines a sentence in the subject book on which the user is focusing attention (i.e. focus sentence). Specifically, the determination part 1021 firstly detects the line of sight of the user on the basis of an image of the user captured by the camera 104, which will be specifically described later. For example, the determination part 1021 extracts the inner corner of an eye or a corneal reflex from an image of the user (e.g. an image of a user's eye) captured by the camera 104 as a reference point and the iris or the pupil as a moving point. The determination part 1021 detects the line of sight of the user on the basis of the positional relationship between the reference point and the moving point. Then, the determination part 1021 determines a sentence in the subject book to which the line of sight of the user is directed on the basis of the positional relationship between the user and the subject book. Then, the determination part 1021 measures the length of time over which the line of sight of the user is directed to each sentence, which will also be referred to as “the reading time” hereinafter. When the reading time of a certain sentence exceeds a predetermined threshold, the determination part 1021 determines this sentence as a focus sentence. Alternatively, the determination part 1021 may determine a focus sentence on the basis of the number of times that the line of sight of the user is directed to each sentence, which will also be referred to as “the number of times of reading” hereinafter. Specifically, the determination part 1021 counts the number of times that the line of sight of the user is directed to each sentence. If the number of times of reading of a certain sentence exceeds a predetermined threshold, the determination part 1021 may determine this sentence as a focus sentence. The predetermined threshold mentioned above is a threshold of the reading time or a threshold of the number of times of reading above which it may be assumed that the sentence is interesting to the user or difficult for the user to understand. Such a threshold may be set, for example, on the basis of a statistical value determined in advance. The determination part 1021 sends information about the focus sentence determined by it to the obtaining part 1022. Specifically, the determination part 1021 may send to the obtaining part 1022 image data obtained by capturing an image of the focus sentence or data representing the text string of the focus sentence.

The obtaining part 1022 obtains information relating to what the focus sentence determined by the determination part 1021 describes (i.e. related information). Specifically, the obtaining part 1022 firstly analyzes what the focus sentence describes. For example, the obtaining part 1022 analyzes what the focus sentence describes by performing natural language processing on the focus sentence. Then, the obtaining part 1022 obtains related information on the basis of what the focus sentence describes. If what the focus sentence describes is a practice problem for learning, the obtaining part 1022 may obtain information suggesting how to solve the practice problem (or a hint for solving the problem) as related information. Alternatively, the obtaining part 1022 may obtain a problem similar to the aforementioned practice problem as related information. In this connection, the obtaining part may obtain information indicating a page of the subject book that provides information suggesting how to solve the practice problem and/or a problem similar to the practice problem as related information. Such a page will also be referred to as a “related page” hereinafter. The obtaining part 1022 may obtain information indicating a book other than the subject book that provides information suggesting how to solve the practice problem and/or a problem similar to the practice problem as related information. Such a book will also be referred to as a “related book” hereinafter. The obtaining part 1022 may obtain both or only one of the information indicating a related page and the information indicating a related book. If information relating to what the focus sentence describes is contained in the subject book, the obtaining part 1022 may obtain information indicating a related page as related information; if information relating to what the focus sentence describes is not contained in the subject book, the obtaining part 1022 may obtain information indicating a related book as related information. Various related information described as above is obtained based on information stored in the storage unit 103, which will be specifically described later. Alternatively, various related information may be obtained using an external service. Specifically, various related information may be obtained using an external service that provides information about a related page or a related book in response to input of information about what the focus sentence describes. The related information obtained in this way is passed from the obtaining part 1022 to the display processing part 1023.

The display processing part 1023 executes the processing of causing the user's terminal 200 to display the aforementioned related information. Specifically, the display processing part 1023 creates a command that causes the user's terminal 200 to display the related information. This command will also be referred to as “display command” hereinafter. The display command in this embodiment contains related information and a command to display the related information. The display command created by the display processing part 1023 is sent to the user's terminal 200 through the communication unit 101.

The storage unit 103 stores various information. The storage unit 103 is constituted by a storage medium, such as RAM, a magnetic disk, or a flash memory. What is stored in the storage unit 103 includes various programs executed by the control unit 102 and various data. In the system according to this embodiment, a book management database 1031 is constructed in the storage unit 103. The book management database 1031 is constructed by managing data stored in the storage unit 103 by a database management system program (DBMS program) executed by the processor. The book management database 1031 is, for example, a relational database.

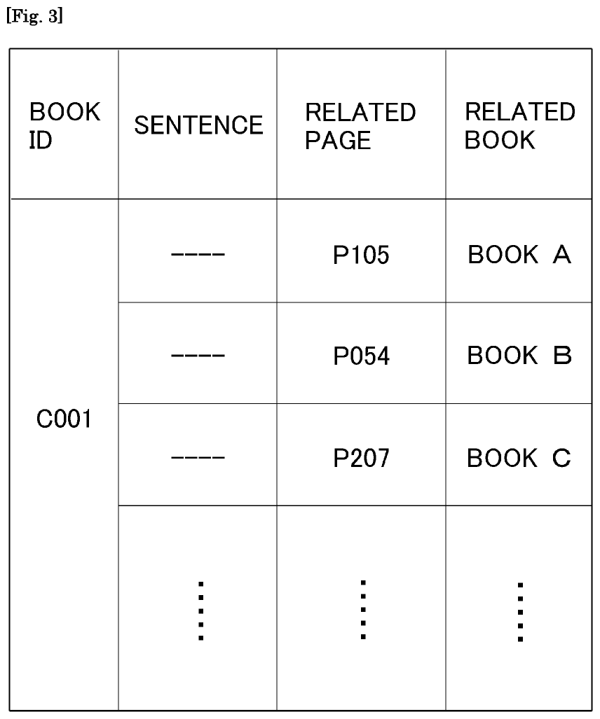

What is stored in the book management database 1031 is information relating to sentences included in the subject book. The book management database 1031 links each sentence contained in the subject book and related information. An example of information stored in the book management database 1031 will be described with reference to FIG. 3. FIG. 3 illustrates a table structure of information stored in the book management database 1031. While FIG. 3 illustrates a case where there is only one subject book, there may be a plurality of subject books.

As illustrated in FIG. 3, a table stored in the book management database 1031 (which will also be referred to as the “book information table”) has the fields of book ID, sentence, related page, and related book. What is stored in the book ID field is information for identifying each subject book (or book ID). The book ID may be the title of the subject book or an item number or the like assigned to the subject book. What is stored in the sentence field is information for identifying each of the sentences included in the subject book. In the case of this embodiment, what is stored in the sentence field is information relating to details of each of the practice problems included in the subject book. Examples of such information include data indicating details of each practice problem, data indicating a reference number of each practice problem, and data indicating the location of each practice problem in the subject book (e.g. page and paragraph). What is stored in the related page field is information indicating a related page in the subject book that relates to what each sentence describes. In the case of this embodiment, what is stored in the related page field is information indicating a page in the subject book that contains information suggesting how to solve each practice problem or a problem similar to each practice problem. The information stored in the related page field may be either information indicating a single related page or information indicating a plurality of related pages. What is stored in the related book field is information indicating a related book that relates to what each sentence describes. In the case of this embodiment, what is stored in the related book field is information indicating a book that contains information suggesting how to solve each practice problem or a book in which a problem similar to each practice problem is provided. The information stored in the related book field may be either information indicating a single related book or information indicating a plurality of related books.

The camera 104 includes a camera used to detect the line of sight of the user and a camera used to capture an image of sentences in the subject book. The camera 104 is set in a place where the user can read a book (e.g. user's own home, a library, a store, or a passenger room of public transportation means). A camera that the user's terminal 200 has may be used as the camera 104.

The camera for detecting the line of sight captures an image of a reference point (or immobile part) and a moving point (or moving part) of a user's eye. The camera for detecting the line of sight may be a visible light camera. In that case, the camera for detecting the line of sight may capture an image of the inner corner of a user's eye (as the reference point) and the iris of the user's eye (as the moving point). Alternatively, the camera for detecting the line of sight may include an infrared LED for illuminating the user's face (or eye) with infrared light and an infrared camera. In that case, the camera for detecting the line of sight may capture an image of the corneal reflex (as the reference point) and the pupil (as the moving point). The corneal reflex is the location of reflected infrared light on the cornea of the user's eye. The image including the reference point and the moving point is sent from the camera 104 to the determination part 1021 through a network or other means and used to detect the line of sight.

The camera used for capturing an image of sentences in the subject book is a visible light camera. This camera captures an image of sentences in the subject book. The image of sentences is sent from the camera 104 to the determination part 1021 through a network or other means and used to determine the focus sentence as described above.

In the case where the camera used to detect the line of sight is a visible light camera, a single camera may serve as both the camera for detecting the line of sight and the camera for capturing an image of the focus sentence.

Various processing executed by the server apparatus 100 configured as above may be executed by either hardware or software.

(User's Terminal 200)

Next, the user's terminal 200 will be described. The user's terminal 200 is a computer used by the user. The user's terminal 200 may be, for example, a terminal that the user can carry, such as a smartphone, a cellular phone, a tablet computer, or a wearable computer (e.g. a smartwatch), or a stationary personal computer.

As illustrated in FIG. 2, the user's terminal 200 of this embodiment includes a communication unit 201, a control unit 202, a storage unit 203, and an input and output unit 204. The configuration of the user's terminal 200 is not limited to that illustrated in FIG. 2, but some components may be eliminated, replaced by other components, or added fitly.

The communication unit 201 is a wireless interface that connects the user's terminal 200 to a network. The communication unit 201 is connected to the network using a mobile communication service, such as 5G mobile communications or LTE mobile communications, or a wireless communication network, such as Wi-Fi (registered trademark), to communicate with the server apparatus 100.

The control unit 202 is constituted by, for example, a microcomputer and performs overall control of the user's terminal 200. For example, the control unit 202 presents related information provided from the server apparatus 100 to the user through the input and output unit 204, which will be specifically described later.

The storage unit 203 stores various information. The storage unit 203 is constituted by a storage medium, such as a RAM, a magnetic disk, or a flash memory. The storage unit 203 stores various programs executed by the control unit 202 and various data.

The input and output unit 204 receives input operations conducted by the user and presents information to the user. The input and output unit 204 is constituted by, for example, a touch panel and its control circuit, a liquid crystal display and its control circuit, a microphone and its control circuit, and a speaker and its control circuit. The touch panel and the liquid crystal display may be constituted by a single touch panel display. The input and output unit 204 of this embodiment outputs related information provided from the server apparatus 100 through the touch panel display.

Various processing executed by the user's terminal 200 configured as above may be executed by either hardware or software.

### (Process Performed by Server Apparatus)

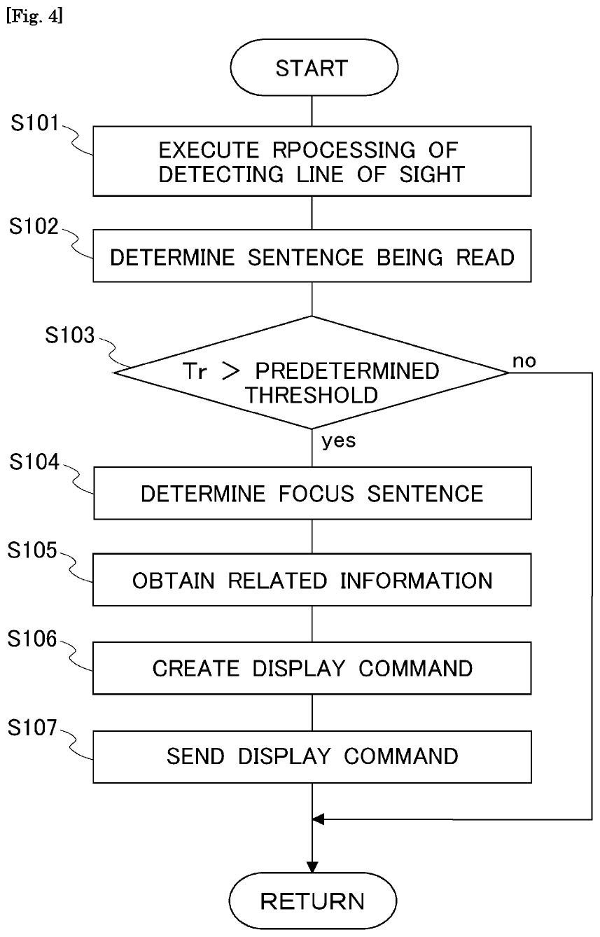

A process performed by the server apparatus 100 of this embodiment will be described with reference to FIG. 4. FIG. 4 is a flow chart of a process executed by the server apparatus 100 repeatedly while the user is reading a subject book.

In the processing routine according to the flow chart of FIG. 4, the determination part 1021 of the server apparatus 100 executes the processing of detecting the user's line of sight (step S101). Specifically, the determination part 1021 firstly analyzes an image of the user captured by the camera for detecting the line of sight included in the camera 104 to determine the positional relationship between a reference point (e.g. the inner corner of an eye or a corneal reflex) and a moving point (e.g. the iris or the pupil). Then, the determination part 1021 detects the user's line of sight on the basis of the positional relationship between the reference point and the moving point.

The determination part 1021 determines a sentence in the subject book to which the user's line of sight is directed (namely, the sentence that the user is reading) on the basis of the line of sight detected in step S101 and the image captured by the camera for capturing an image of sentences included in the camera 104 (step S102). In this process, the determination part 1021 may determine the positional relationship between the user and the subject book using a camera provided separately from the camera for detecting the line of sight and the camera for capturing an image of sentences. Then, the determination part 1021 may determine the sentence that the user is reading on the basis of the line of sight detected in step S101, the image captured by the camera for capturing an image of sentences, and this positional relationship.

The determination part 1021 determines whether the time (reading time Tr) over which the user's line of sight is directed to the sentence determined in step S102 exceeds a predetermined threshold (step S103). As described above, the predetermined threshold is a threshold of the reading time Tr above which it may be assumed that the sentence is interesting to the user or difficult for the user to understand. If the reading time Tr does not exceed the predetermined threshold (a negative answer in step S103), the execution of this routine is terminated this time. On the other hand, if the reading time Tr exceeds the predetermined threshold (an affirmative answer in step S103), the processing of step S104 is executed next.

In step S104, the determination part 1021 sets the sentence determined in step S102 (i.e. the sentence the user is reading) as a focus sentence. For example, the determination part 1021 extracts an image of the focus sentence from the image captured by the camera for capturing an image of sentences. The image of the focus sentence extracted in this way is passed from the determination part 1021 to the obtaining part 1022.

The obtaining part 1022 obtains related information on the basis of the image passed from the determination part 1021 (step S105). In this process, the obtaining part 1022 firstly analyzes what the focus sentence describes. For example, the obtaining part 1022 extracts the text string from the image of the focus sentence and applies natural language processing on the extracted text string to thereby analyze what the focus sentence describes. In this embodiment, “what the focus sentence describes” refers to, for example, details of the practice problem that the focus sentence describes, a reference number of the practice problem that the focus sentence describes, or the location of the practice problem that the focus sentence describes in the subject book (i.e. page and paragraph). The obtaining part 1022 accesses the book management database 1031 using the book ID of the subject book and the result of the above analysis as arguments to obtain related information relating to what the focus sentence describes. Specifically, the obtaining part 1022 finds a book information table in which information same as the book ID of the subject book is stored in its book ID field from among the book information tables stored in the book management database 1031. The book ID of the subject book can be obtained by capturing an image of the front cover, the backbone, or the back cover of the subject book by the camera 104 when the user starts to read it. In the case where the subject book is an electronic book stored in the user's terminal 200, the obtaining part 1022 may obtain the book ID of the subject book by communicating with the user's terminal 200 through the communication unit 101. Alternatively, the user may register the book ID of the subject book on the server apparatus 100 through the user's terminal 200. Then, the obtaining part 1022 finds a sentence field in which information same as what the focus sentence describes is stored from among the sentence fields of the book information table found as above. Then, the obtaining part 1022 extracts the information stored in the related page field and the information stored in the related book field that are linked with the sentence field found as above. The related information obtained in this way is passed from the obtaining part 1022 to the display processing part 1023. Related information relating to the focus sentence may be obtained using a service that provides related information in response to input of information about what the focus sentence describes, as described before.

The display processing unit 1023 creates a display command on the basis of the related information passed from the obtaining part 1022 (step S106). As described above, the display command is a command for causing the user's terminal 200 to display the related information. The display command contains the related information. The display command created by the display processing part 1023 is sent to the user's terminal 200 through the communication unit 101 (step S107). Consequently, the control unit 202 of the user's terminal 200 causes the input and output unit 204 to display the related information contained in the display command. When causing the input and output unit 204 to display the related information, the control unit 202 of the user's terminal 200 may cause the input and output unit 204 to output notification sound to call user's attention.

As above, when the user meets a sentence that is interesting to him/her or difficult for him/her to understand when reading a subject book, the processing routine according to the flow chart of FIG. 4 can cause the user's terminal 200 to automatically display related information or information relating to that sentence (i.e. focus sentence). In consequence, the user can learn the related information displayed on the user's terminal 200 to deepen the understanding of what the focus sentence describes. Thus, the user can deepen the understanding of what the focus sentence describes without taking time and effort for searching related information or related literature relating to what the focus sentence describes. This improves the efficiency of user's learning.

The processing routine according to the flow chart of FIG. 4 provides related information through the user's terminal 200 only for the sentences in the subject book that are interesting to the user or difficult for the user to understand (or the sentences for which the reading time or the number of times of reading exceeds a predetermined threshold). Therefore, it can improve the convenience of the user without inviting a decrease in the user's understanding or bothering the user.

### <Modification>

While the subject book described in the above description of the embodiment is a book that contains practice problems for learning, the subject book to which the technology disclosed herein is applied is not limited to this. The subject book may be a book relating to other subjects, such as philosophy, society, industry, art, and literature.

### <Others>

The above embodiment and modification have been described only by way of example. Modifications can be made to them without departing from the essence of this disclosure. For example, the processing performed by the server apparatus 100 may be performed partly or entirely by the user's terminal 200. For example, the processing of determining a focus sentence and the processing of obtaining related information may be performed at least partly by the user's terminal 200. The processing of determining a focus sentence and the processing of obtaining related information may be performed at least partly by an information processing apparatus other than the server apparatus 100.

The processes that have been described in this disclosure may be employed in any combination so long as it is technically feasible to do so. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) (or information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of the computer-readable, non-transitory storage medium include any type of disc medium including a magnetic disc, such as a floppy disc (registered trademark) and a hard disk drive (HDD), and an optical disc, such as a CD-ROM, a DVD and a Blu-ray disc. The computer-readable, non-transitory storage medium may include other storage media, such as a read-only memory (ROM), a random access memory (RAM), an EPROM, an EEPROM, a magnetic card, a flash memory, an optical card, and a solid state drive (SSD).

What is claimed is:

1. An information processing apparatus comprising a controller including at least one processor, the controller being configured to execute the processing of:
determining a focus sentence in a subject book that a user is reading, the focus sentence being a sentence on which the user is focusing attention;
analyzing what the focus sentence describes and obtaining related information relating to what the focus sentence describes; and
causing a user's terminal that the user is using to display the related information.

2. An information processing apparatus according to claim 1, wherein the controller analyzes what the focus sentence describes and obtains information suitable for explanation of what the focus sentence describes as related information

3. An information processing apparatus according to claim 2, wherein what the focus sentence describes is a practice problem for learning, and the controller obtains information suggesting how to solve the practice problem as the related information.

4. An information processing apparatus according to claim 1, wherein the controller analyzes what the focus sentence describes and obtains information similar to what the focus sentence describes as the related information.

5. An information processing apparatus according to claim 4, wherein what the focus sentence describes is a practice problem for learning, and the controller obtains information relating to a practice problem similar to the practice problem as the related information.

6. An information processing apparatus according to claim 1, wherein the controller obtains information indicating a page of the subject book that contains a description of information relating to what the focus sentence describes as related information.

7. An information processing apparatus according to claim 1, wherein the controller obtains information indicating a book other than the subject book that contains a description of information relating to what the focus sentence describes as related information.

8. An information processing apparatus according to claim 1, wherein the controller executes the processing of causing a user's terminal to display the related information when the length of time over which the user is focusing attention on the focus sentence exceeds a predetermined threshold or when the number of times that the user focuses attention on the focus sentence exceeds a predetermined threshold.

9. An information processing apparatus according to claim 1, wherein the subject book is a paper book.

10. An information processing apparatus according to claim 1, wherein the controller detects a line of sight of the user by analyzing an image of the user captured by a camera and determines the focus sentence on the basis of the detected line of sight.

11. An information processing method comprising the following steps of processing executed by a computer:
a first step of determining a focus sentence in a subject book that a user is reading, the focus sentence being a sentence on which the user is focusing attention;
a second step of analyzing what the focus sentence describes and obtaining related information relating to what the focus sentence describes; and
a third step of causing a user's terminal that the user is using to display the related information.

12. An information processing method according to claim 11, wherein the second step comprises analyzing what the focus sentence describes and obtaining information suitable for explanation of what the focus sentence describes as related information

13. An information processing method according to claim 12, wherein what the focus sentence describes is a practice problem for learning, and the second step comprises obtaining information suggesting how to solve the practice problem as the related information.

14. An information processing method according to claim 11, wherein the second step comprises analyzing what the focus sentence describes and obtaining information similar to what the focus sentence describes as the related information.

15. An information processing method according to claim 14, wherein what the focus sentence describes is a practice problem for learning, and the second step comprises obtaining information relating to a practice problem similar to the practice problem as the related information.

16. An information processing method according to claim 11, wherein the second step comprises obtaining information indicating a page of the subject book that contains a description of information relating to what the focus sentence describes as related information.

17. An information processing method according to claim 11, wherein the second step comprises obtaining information indicating a book other than the subject book that contains a description of information relating to what the focus sentence describes as related information.

18. An information processing method according to claim 11, wherein the third step is executed when the length of time over which the user is focusing attention on the focus sentence exceeds a predetermined threshold or when the number of times that the user focuses attention on the focus sentence exceeds a predetermined threshold.

19. An information processing method according to claim 11, wherein the subject book is a paper book.

20. A non-transitory storage medium storing an information processing program configured to cause a computer to execute the following steps of:
a first step of determining a focus sentence in a subject book that a user is reading, the focus sentence being a sentence on which the user is focusing attention;
a second step of analyzing what the focus sentence describes and obtaining related information relating to what the focus sentence describes; and
a third step of causing a user's terminal that the user is using to display the related information.
